(19) United States
(12) Patent Application Publication
(10) Pub. No.: US 2005/0246901 A1
(43) Pub. Date: Nov. 10, 2005

(54) Reciprocating power tool

(76) Inventors: Li Chengdao, Suzhou (CN); Zhang Bin, Huayanghuayuan Suzhou Jiangsu Province (CN)

Correspondence Address: James V Costigan;Hedman & Costigan, 1185 Avenue of the Americas, New York, NY, 10036-2601, US

(21) Appl. No.: 10/516,561

(22) PCT Filed: May 27, 2003
(86) PCT No.: PCT/IB03/02037

§ 371 Date: Jun. 9, 2005

(30) Foreign Application Priority Data
May 27, 2002 (CN) 02113121.X

(51) Int. Cl. B27B 5/29; B27B 19/09

(52) U.S. Cl. 30/166.3

(57) ABSTRACT

The present invention relates to a reciprocating power tool, more particularly, relates to a clamping device for a blade which will cut the workpiece when the cutting work is doing. The reciprocating power tool comprises: a housing, a reciprocating rod subassembly, an operating member clamping mechanism. The operating member clamping mechanism includes an actuating subassembly, a locking subassembly, said actuating subassembly includes a rotating sleeve, a sliding block, there is thread provided in the inner surface of the rotating sleeve, a guiding projection outside the sliding block inserts into said thread grooves, an inclined guiding surface provided with the interior of the sliding block is engaged with the corresponding inclined guiding surface which is provided with a locking pin, by the guiding projection engaging with said thread grooves, when the rotating sleeve rotate and then carry the guiding projection moving in the axial direction of the reciprocating rod subassembly, then the sliding block carry the locking pin moving in the radial direction, thus the operation is easy to carry through and the rotating sleeve is rotatable in a large angle range.

### TECHNICAL FIELD

The present invention relates to a reciprocating power tool with an operating member clamping mechanism.

### BACKGROUND OF THE INVENTION

In the prior art, U.S. Pat. No. 6,209,208 has disclosed a clamping mechanism, which composed of an outer cam surface and an inner cam surface, a locking subassembly includes an outer follower surface adapted to be driven by said outer cam surface and an inner follower surface adapted to be driven by said cam surface, whereby, the locking subassembly can move in the radial direction and lock the blade when actuating subassembly rotates. Said inner cam surface directly press on the said outer cam surface to actuate the later move in the radial direction, that result in the difficult operation of this kind of clamping device. Furthermore, the components which composed of said clamping device almost are cutting members, these components own relative large manufacturing errors, and these errors are accumulated when all components are assembled together. And it is much difficult to manufacture this kind integral cam.

### INVENTION CONTENT

The present invention is to provide a new and improved blade clamping mechanism with easy operating structure for reciprocating power tools.

The technical proposal of the present invention is: a reciprocating power tool, which comprises:
A housing;
A reciprocating rod subassembly, which exerts reciprocating movement in said housing, has an end for receiving an operating member;
An operating member clamping device, which is provided on the said reciprocating rod subassembly; further said operating member clamping device also includes:
   An actuating subassembly, which disposed on said end of said reciprocating rod subassembly, said actuating member has an engaged position and a disengaged position, said actuating member can move relative to said reciprocating rod subassembly between the engaged position and said disengaged position;
   A locking subassembly, which has two operating positions, a first locking position is the operating member being locked in the reciprocating rod subassembly, a second unlocking position is said operating member being released, said locking subassembly is movable between these two operating positions. Said locking subassembly moves from said first locking position to said second unlocking position when said actuating subassembly moves from said engaged position to said disengaged position; said locking subassembly moves from said second unlocking position to said first locking position when said actuating subassembly moves from said disengaged position to said engaged position;
   Said actuating subassembly includes at least one rotating sleeve which is rotatable relative to said reciprocating rod subassembly, one sliding block which can slide relative to said reciprocating rod subassembly in the axis direction of said reciprocating rod subassembly, there are thread grooves in the inner surface of said rotating sleeve, there is a guiding projection in the exterior side of the sliding block, and said guiding projection insert into the thread grooves, and inclined or curved guiding surface are provided in the interior side of said sliding block;
   Said locking subassembly includes at least one pin which is movable relative to said reciprocating rod subassembly, the outside end of the said pins configured in the inclined or curved guiding surface which contact with the corresponding inclined or curved guiding surface of the sliding block.

Compared with the prior art, the present invention own the following advantages: by design said thread grooves engaging with said projection, said projection is carrying and moving easily in the axial direction of the reciprocating rod subassembly when said rotating sleeve is rotating and actuating said sliding block carry the pin moving in the radial direction, whereby such a clamping mechanism is easily operated by an operator.

### BRIEF DESCRIPTION OF THE DRAWINGS

FIG. 1 shows a sectional view of the operating member clamping mechanism in the first embodiment responsible to the present invention, operating member is being released;

FIG. 2 shows a sectional view of the operating member clamping mechanism in the first embodiment responsible to the present invention, operating member is being locked;

FIG. 3 shows the main view of the operating member clamping mechanism;

FIG. 4 shows the sectional view along the line D-D of the FIG. 3. (An operating member released);

FIG. 5 shows the sectional view along the line D-D of the FIG. 3. (An operating member locked);

FIG. 6 shows the left view of the operating member clamping mechanism;(An operating member released)

FIG. 7 shows the sectional view along the line A-A of the FIG. 3. (An operating member locked);

FIG. 8 shows the sectional view along the line A-A of the FIG. 3. (An operating member released);

FIG. 9 shows a sectional view of the operating member clamping mechanism in the second embodiment responsible to the present invention; (An operating member released)

FIG. 10 shows a sectional view of the operating member clamping mechanism in the first embodiment responsible to the present invention; (An operating member locked)

FIG. 11 shows the sectional view along the line D-D of the operating member clamping mechanism in the second embodiment;(An operating member released)

FIG. 12 shows the sectional view along the line D-D of the operating member clamping mechanism in the second embodiment; (An operating member locked)

FIG. 13 shows an exploded perspective view of the reciprocating rod subassembly and the operating member clamping mechanism;

FIG. 14 shows a shape view of the present invention;

FIG. 15 shows three enlarged projective views of said sliding block;

FIG. 16 shows two enlarged projective views of said fork sleeve;

FIG. 17 shows two enlarged projective views of said pin body;

FIG. 18 shows the sectional view along a longitudinal direction center plane E;

FIG. 19 shows a projective view of two inner sleeves;

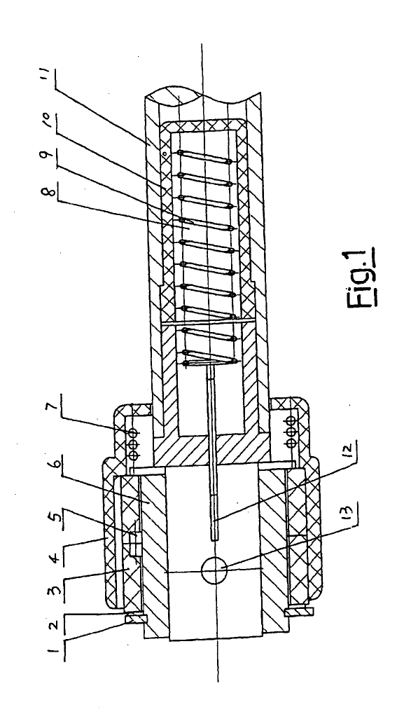

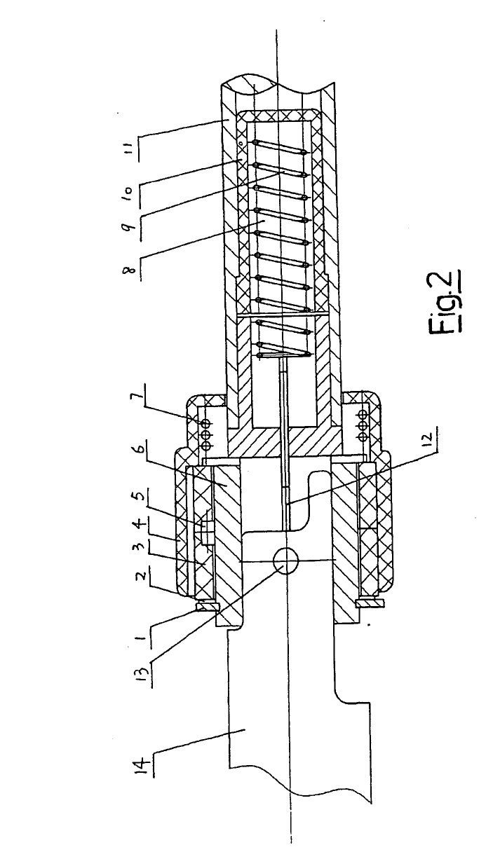

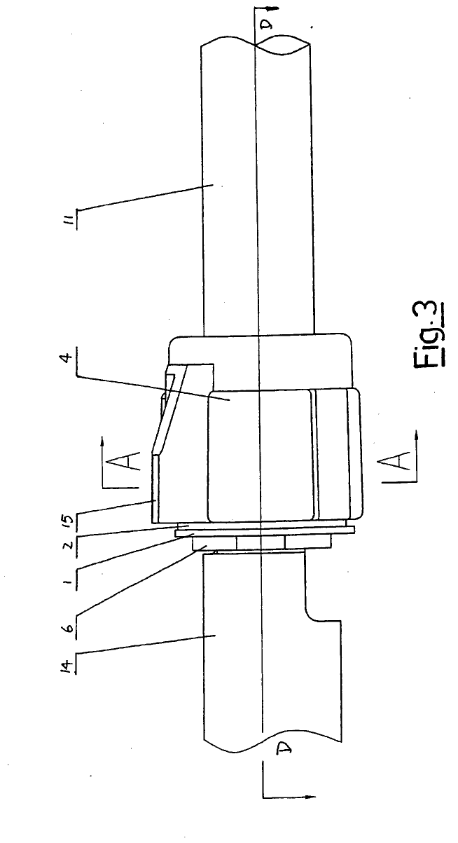

In all the FIGS., the number respectively indicated to: [1]□a compressing ring ; [2]□a washer ; [3]□an inner sleeve ; [4]□an outer sleeve; [5]□the thread groove ; [6]□a fork sleeve ; [7]□a first torsion spring ; [8]□a compressing groove; [9]□a compression spring; [10]□a sleeve; [11]□a reciprocating rod subassembly; [12]□a pushing plate; [13]□a pin; [14]□a operating member; [15]□an actuating ear; [16]□a slot; [17]□a second torsion spring; [18]□a sliding block; [19]□an inclined surface; [20]□a fork; [21]□a guiding projection; [22]□a pin body; [23]□an elastic cylindrical pin; [24]□the sliding groove of the sliding block.

### DESCRIPTION OF THE PREFERRED EMBODIMENTS

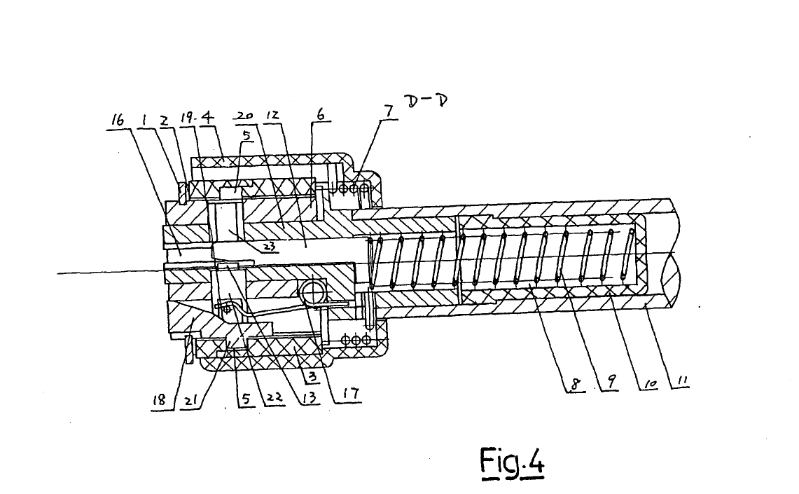

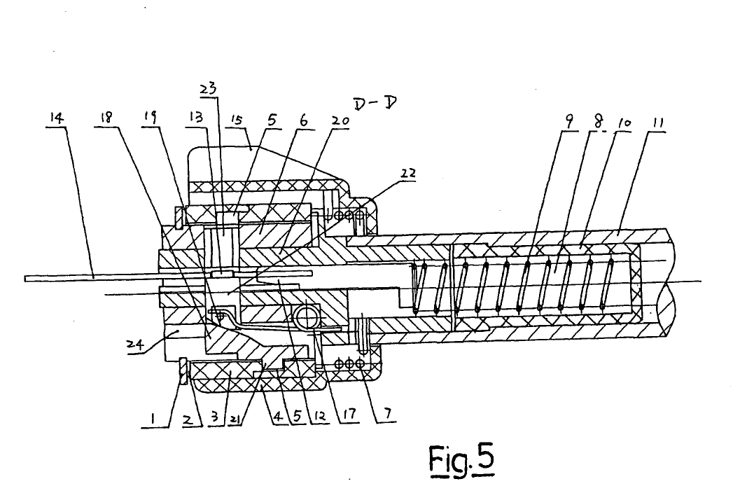

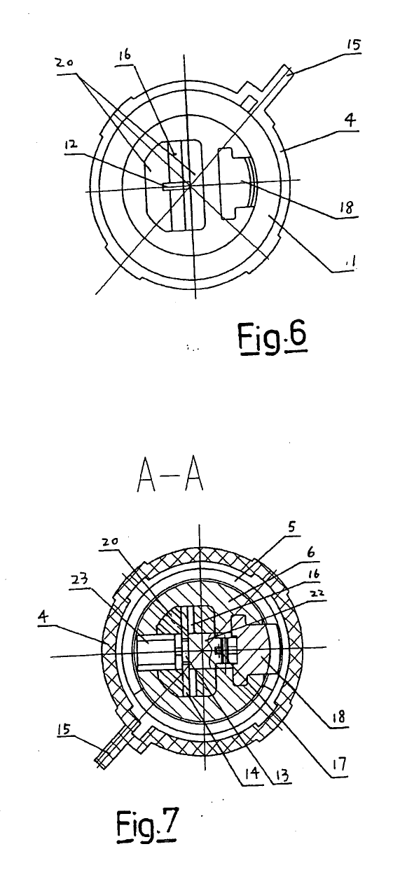

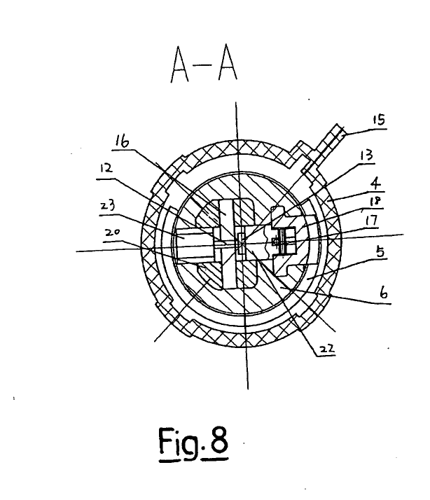

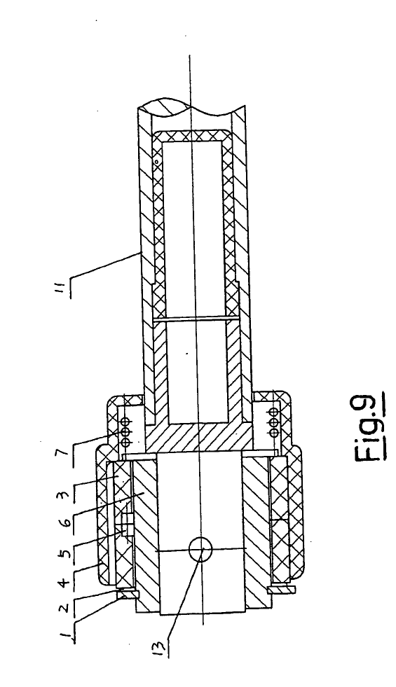

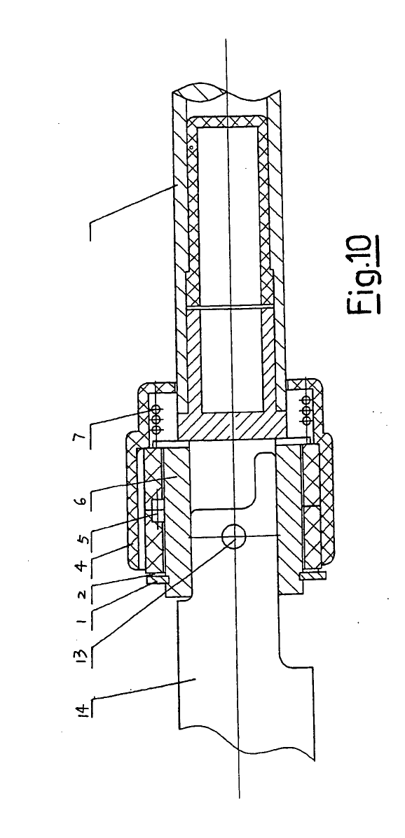

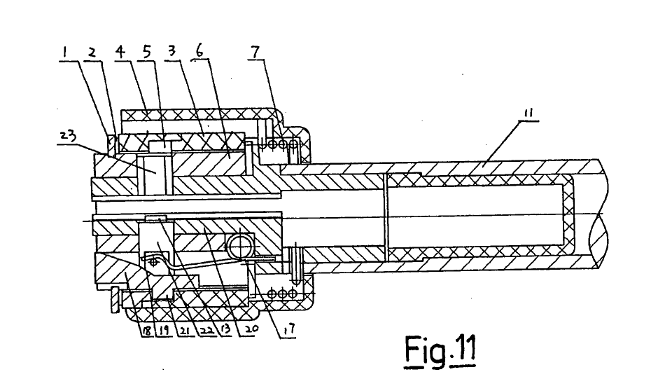

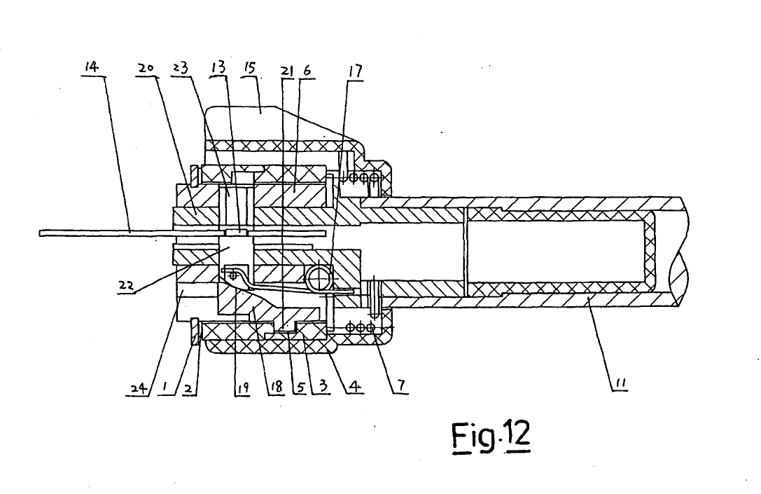

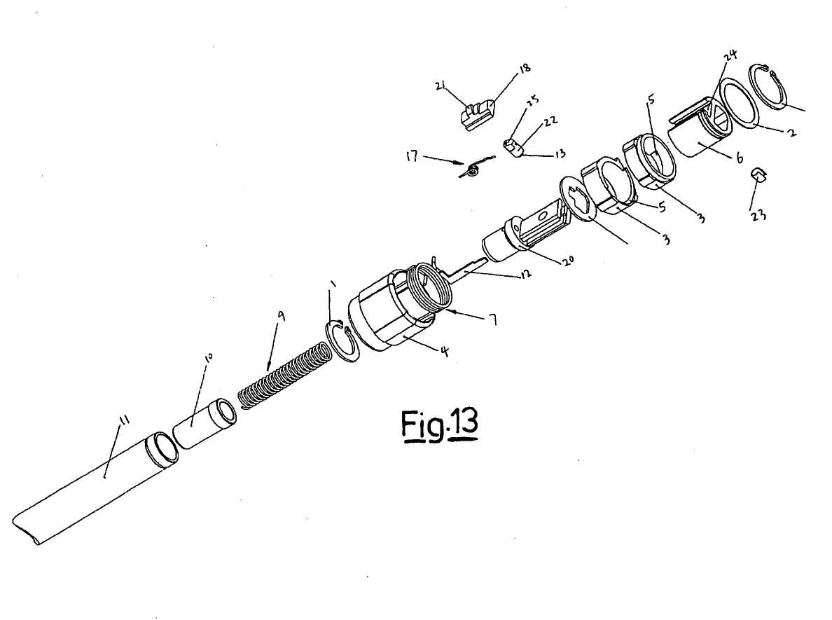

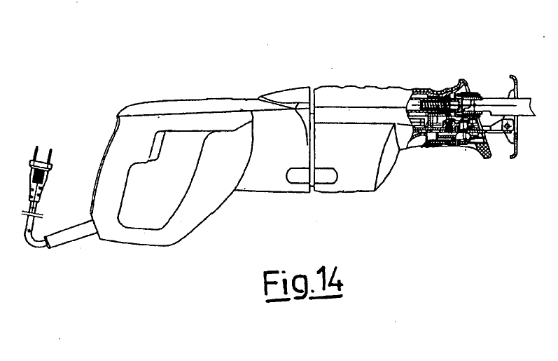

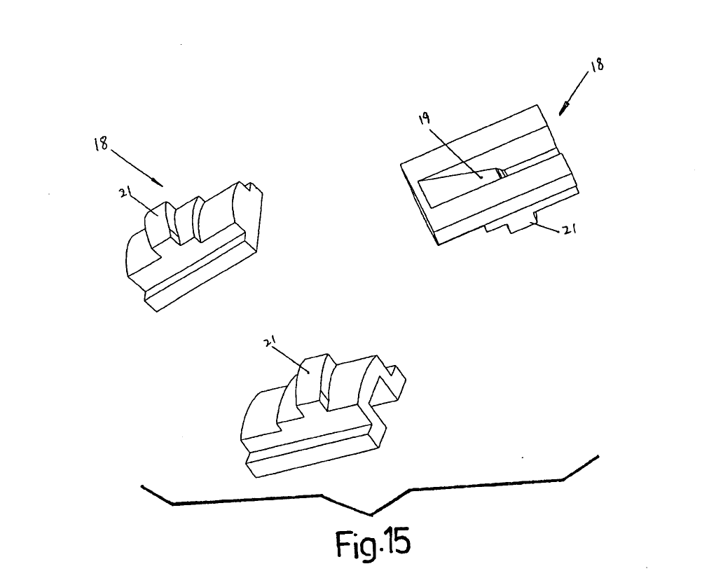

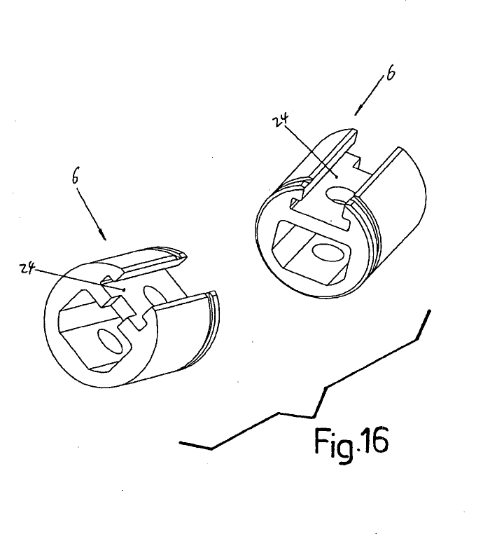

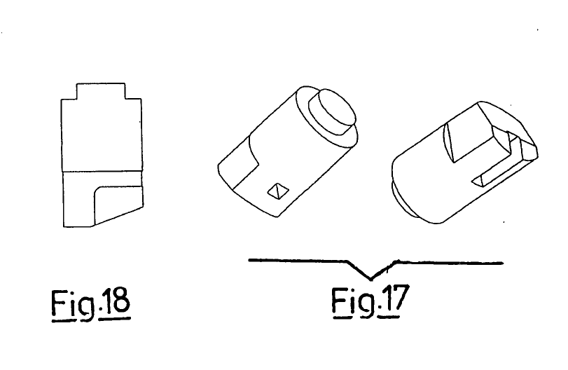

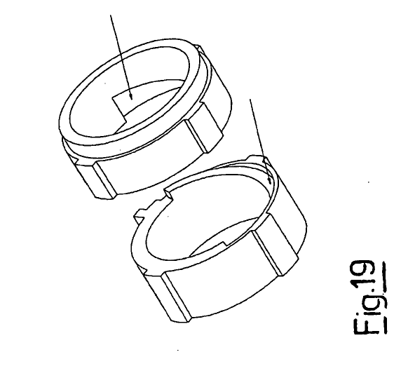

The present invention is a reciprocating power tool (see FIG. 14), which comprises:
A housing;
A reciprocating rod subassembly at least includes a projecting rod, a fork and a fork sleeve, which exerts reciprocating movement in said housing and has an end receiving an operating member [14];
An operating member clamping device which is provided on said reciprocating rod subassembly [11]; further said operating member clamping device also includes:
   An actuating subassembly, which disposed on said end of said reciprocating rod subassembly, said actuating member has an engaged position (see FIG.5 and FIG. 12) and a disengaged position (see FIG. 4 and FIG. 11), said actuating member is movable relative to said reciprocating rod subassembly between the engaged position and said disengaged position;
   A locking subassembly, which has two operating positions, a first locking position (see FIG. 5 and FIG. 12) is the operating member [14] being locked in the locking position of said reciprocating rod subassembly, a second unlocking position (see FIG. 4 and FIG. 11) is said operating member being released, said locking subassembly is movable between these two operating positions. Said locking subassembly moves from said first locking position to said second unlocking position when said actuating subassembly moves from said engaged position to said disengaged position; said locking subassembly moves from said second unlocking position to said first locking position when said actuating subassembly moves from said disengaged position to said engaged position;
   Said actuating subassembly at least includes one rotating sleeve which is rotatable relative to said reciprocating rod subassembly, one sliding block [18] which is slidable relative to said reciprocating rod subassembly in the axial direction of said reciprocating rod subassembly, there are thread grooves [5] in the inner surface of said rotating sleeve, there is a guiding projection [21] in the exterior of the sliding block [18], and said guiding projection [21] insert into the thread grooves [5], inclined or curved guiding surface are provided in the interior side of said sliding block [18]; said rotating sleeve is a connected member which composed of the outer sleeve [4] and the inner sleeve [3].

Said locking subassembly at least includes one pin body [22] which is movable relative to said reciprocating rod subassembly, the outside end of said pin body [22] configured in the inclined or curved surface [25] which contact with the corresponding inclined or curved surface [19] which formed on said sliding block [18], whereby the pin body [22] move in the radial direction when the sliding block move in the axial direction of the reciprocating rod subassembly

Two end portions of a second torsion spring [17] respectively connect with said pin body [22] and said reciprocating rod subassembly, and said second torsion spring [17] make said pin body [22] have a tendency of moving from the locking position to the unlocking position.

There is a first torsion spring [7] which ring the outside of said reciprocating rod subassembly, and one end of the first torsion spring [7] connect with said reciprocating rod subassembly, and the other end of said first torsion spring [7] connect with the rotating sleeve. FIG. 4 shows the condition of said first torsion spring connecting to the outer sleeve [4] of the rotating sleeve.

The outer surface of the said rotating sleeve has actuating ears [15] which is extended in the radial direction, rotate said actuating ears [15], thus said rotating sleeve is carried to be rotating.

FIG. 12, a axially extending sliding groove of sliding block [24] is disposed on said reciprocating rod subassembly, said sliding block [18] is disposed in said sliding groove [24] and is movable in the axial direction. In detailed, one end portion of said reciprocating rod subassembly is a forked body [20], a fork body sleeve [6] ring outside of the forked body [20], and a elastic cylindrical pin [23] joined the sleeve [6] and the forked body [20] and thereby formed an integrative member. Said sliding groove of sliding block [24] is set in the wall of the said fork body sleeve [6].

The end portion of said reciprocating rod subassembly for receiving the operating member [14] has a slot [16] provided for containing said operating member [14]; said reciprocating rod subassembly has a hole which is open in the radial direction for receiving the said pin body (in the first embodiment, the hole is in the end portion of the reciprocating rod subassembly), a pin [22] insert into the hole, the pin body [22] is movable relative to the forked body [20] in the radial direction, the inner end of the pin body [22] is inside said slot [16] when the pin body [22] is in its locking position, see FIG. 4, the inner end of the said pin body [22] is a pin [13] whose radius is gradually becoming smaller, in the locking position, the pin [13] of the said pin body is inserted into the hole which is in the operating member [14], whereby the operating member is secured in its locking position.

The end portion of said reciprocating rod subassembly for receiving the operating member [14] has a slot [16] provided for containing said operating member [14]; a pushing plate [12] which is movable in the axial direction is inserted into said slot [16], the pushing plate insert between the inner end of the pin body [22] and the side wall of the slot [16] when said pin body [22] is in its unlocking position, see FIG. 4. The outer end of the pushing plate [12] is pressed on the inner end of the operating member [14] when the pin body [22] is in its locking position, as showed in FIG. 5.

A compression spring [9] is provided between said pushing plate [12] and said reciprocating rod subassembly, and the compression spring [9] make the pushing plate have a tendency to move towards the operating member [14].

In the first embodiment shown in FIG. 4, the first torsion spring [7] is biased on the outer sleeve [4] of the rotating sleeve [6], so the thread groove [5] make the guiding projection [21] which disposed on the sliding block [18] has the tendency of moving towards the right side, the upward force which is coming from the sliding block [18] and exerting onto the pin body [22] is larger than the downward force which is coming from the second torsion spring [17] and exerting onto the pin body [22], while the pushing plate [12] is inserted into the slot [16] and lies above the pin body [22], so the pin [13] is not movable upward. As shown in FIG. 5, the operating member [14] push the pushing plate inward when the operating member [14] (generally is a blade) is inserted into the slot [16], the pin [13] move upward once it is received by the locating hole, whereby the operating member [14] is located in its working position, accordingly, the sliding block [18] and the rotating sleeve move from the unlocking position indicated in FIG. 4 to the locking position. The rotating sleeve and the sliding block [18] leftwards move from the position indicated in FIG. 5 to the position indicated in FIG. 4 (i.e. from the locking position to the unlocking position), so the compression force exerted on the pin body [22] is disappeared, the downward compressing force from the second torsion spring [17] cause the pin [13] move downwardly, thus resulting from the outwardly force exerted by the pushing plate [12], the operating member [14] ejects outwardly, and then is in the condition indicated in FIG. 4, the operating member (generally is a blade) is ejected out while don't need the operator take it out by his/her hand.

In the second embodiment indicated in FIG. 12, the pin [13] get the upward force coming from sliding block [18] and lock the operating member [14] in its locking position, when to take out the operating member [14], rotate the rotating sleeve, then the rotating sleeve and sliding block move from the locking position to unlocking position (move from the position shown in FIG. 12 to the position shown in FIG. 11), accordingly, the pin body [22] move from its locking position to unlocking position, resting in the unlocking position, in this time, the operator can take the operating member [14]out of the slot [16] by hand, loosing the force exerting on the rotating sleeve, the actuating subassembly and locking subassembly return to the locking position automatically.

1. A reciprocating power tool, comprises:
a housing;
a reciprocating rod subassembly which exert a reciprocating movement in said housing, and said reciprocating rod subassembly has an end portion for receiving an operating member;
an operating member locking mechanism which is disposed on said reciprocating rod subassembly; said operating member locking mechanism includes an unlocking position, an actuating subassembly is movable relative to said reciprocating rod subassembly between a locking position and an unlocking position;
a locking subassembly which has two operating positions, a first operating position whereat said operating member is locked to said reciprocating rod subassembly; a second operating position whereat said operating member is unlocked from said reciprocating rod subassembly; said locking subassembly move between said two positions; said locking subassembly move from said locking position to said unlocking position when said actuating subassembly move from said engaged position to said disengaged position; said locking subassembly move from said unlocking position to said locking position when said actuating subassembly move from said engaged position move to said disengaged position;
Characterized in that:
Said actuating subassembly at least includes a rotating sleeve which is rotatable about said reciprocating rod subassembly, a sliding block which is movable relative to said reciprocating rod subassembly in a axial direction, there are thread grooves opened in the inner wall of said rotating sleeve, a guiding projection is provided at the exterior of said sliding block, said guiding projection insert into said thread grooves, the interior of said sliding block is disposed with an inclined or curved guiding surface;
Said locking subassembly at least includes a pin body which is movable relative to said reciprocating rod subassembly in the radial direction, said outer end portion of the pin body is disposed with an inclined or curved guiding surface which is attached with said inclined or curved guiding surface which is provided on said sliding block.

2. A reciprocating power tool of claim 1, wherein said outer end portion of said pin body is respectively connected with two ends of a second torsion spring which give said pin body a tendency moving from a locking position to an unlocking position.

3. A reciprocating power tool of claim 1, wherein said reciprocating rod subassembly outside ring a first torsion spring, an end portion of said first torsion spring is connected to said reciprocating rod subassembly and the other end portion of said first torsion spring is connected to said rotating sleeve.

4. A reciprocating power tool of claim 1, wherein an outer surface of said rotating sleeve is provided with projecting ears.

5. A reciprocating power tool of claim 1, wherein said reciprocating rod subassembly is disposed with a slot which is opened in said axial direction and in which said sliding block inserted.

6. A reciprocating power tool of claim 1, wherein an end portion for receiving said operating member of said reciprocating rod subassembly provided a slot for containing the operating member; said reciprocating rod subassembly provided a hole in the axial direction for receiving said pin, said hole has said pin body inserted into, said inner end portion of said pin body lies in said slot when said pin body lies in its locking position.

7. A reciprocating power tool of claim 1, wherein an end portion of said reciprocating rod subassembly for receiving said operating member is disposed with a slot for containing said operating member, a pushing plate which is movable in the axial direction is accommodated in said slot, said pushing plate extend into therebetween said inner end portion of pin body and side wall of said slot when said pin body lies in its locking position; an outer end portion of said pushing plate press on said inner end portion of said operating member.

8. A reciprocating power tool of claim 1, wherein a compressing spring is provided between said pushing plate and said reciprocating rod subassembly, said compressing spring give said pushing plate a tendency to move towards said operating member.
